(19) United States
(12) Patent Application Publication
(10) Pub. No.: US 2024/0208269 A1
(43) Pub. Date: Jun. 27, 2024

(54) PNEUMATIC TYRE FOR A TWO-WHEELED VEHICLE HAVING A PROTECTIVE LAYER

(71) Applicant: Continental Reifen Deutschland GmbH, Hannover (DE)

(72) Inventors: Daniel Lengemann, Korbach (DE); Andre Schmidt, Medebach (DE); Jan-Niklas Voß, Titz (DE); Artur Zipf, Twistetal (DE); Jan Martin Eder, Hannover (DE)

(73) Assignee: Continental Reifen Deutschland GmbH, Hannover (DE)

(21) Appl. No.: 18/557,740

(22) PCT Filed: Dec. 3, 2021
(86) PCT No.: PCT/DE2021/200238

§ 371 Date: Oct. 27, 2023

(30) Foreign Application Priority Data
Apr. 29, 2021 (DE) 10 2021 204 315.1

(51) Int. Cl. B60C 9/09; B60C 9/11; B60C 15/00

(52) U.S. Cl. CPC B60C 9/09; B60C 9/11; B60C 15/0045; B60C 2200/12

(57) ABSTRACT

A two-wheeler pneumatic tire, in which damage protection and puncture protection are improved while providing good rolling resistance and good tightness; the two-wheeler pneumatic tire in the bead regions has a protective layer which is disposed axially outside the carcass and which has strength members embedded in rubber material; wherein the tire carcass is formed from a first carcass ply and a second carcass ply disposed radially within in a vertex, and wherein the second carcass ply ends with a second carcass ply turn-up in a second carcass ply end in the bead region; the purpose of damage protection and puncture protection is achieved in that the first carcass ply is guided from the respective bead region in a first carcass ply turn-up over the respective tire sidewall to below the tread and at the latter ends in each case in a first carcass ply end; and that in each of the two axial halves the protective layer is guided from the bead region over the respective tire sidewall to below the tread.

### TECHNICAL FIELD

The invention relates to a two-wheeler pneumatic tire, preferably bicycle tire, particularly preferably racing bike or mountain bike tires, having a tread, a tire carcass, tire sidewalls, and in each axial half of the tire a bead region having a tire bead with a core, wherein the two-wheeler pneumatic tire in the bead regions has a protective layer which is axially disposed outside the carcass and which has strength members embedded in rubber material: wherein the tire carcass is formed from a first carcass ply and a second carcass ply, each having strength members; wherein the second carcass ply is disposed in a vertex of the two-wheeler pneumatic tire radially within the first carcass ply, and extends from the vertex of the two-wheeler pneumatic tire over the tire sidewalls to both bead regions, and in the latter wraps the respective core from axially inside to axially outside, and ends in a second carcass ply end radially within a tread end of the tread; and wherein the first carcass ply extends from the vertex of the two-wheeler pneumatic tire over the tire sidewalls to both bead regions, and in the latter wraps the respective core from axially inside to axially outside.

### SUMMARY

Conventional two-wheeler pneumatic tires, preferably bicycle tires, particularly preferably racing bike tires and/or mountain bike tires, are designed and optimized for rolling resistance, puncture protection and mileage. There is, to some extent, a conflict of objectives between these characteristics.

For example, EP 3174738 A1 discloses a racing bike tire having a two-layer carcass, wherein turn-ups of both carcass layers largely cover the sidewalls. Such a tire, at least in a part of the sidewall, is reinforced by four layer thicknesses of the carcass. The construction enables a high degree of cutting resistance for the sidewall. However, the extensive use of carcass material in the region of the sidewall has an adverse effect on weight and rolling resistance.

A typical construction with a single-layer carcass is distinguished by the fact that the turn-ups of the carcass ply extend as far as into the tire vertex and end, so as to overlap one another, below the tread. Such a construction is easy to produce but exhibits lower cutting resistance in the sidewall and thus exhibits lower damage protection in the sidewall.

DE 202020104281 U1 discloses a tire with a two-layer carcass, whereby the carcass turn-ups of both carcass layers already end in the bead region below a bead protection tape. Such a tire is optimized with regard to rolling resistance but exhibits low damage protection.

With tubeless tires, in addition to the tightness itself, the puncture protection in the area of the sidewall is also of particular importance, since such damage, when using a sealant fluid, cannot usually be repaired by the sealant fluid.

The invention is based on the object of providing a two-wheeler pneumatic tire, preferably a bicycle tire, particularly preferably a racing bike and/or a mountain-bike tire, in which damage protection and puncture protection are improved while providing good rolling resistance and good tightness.

The object is achieved in that the first carcass ply is guided from the respective bead region in a first carcass ply turn-up over the respective tire sidewall to below the tread, and at the latter ends in each case in a first carcass ply end, and in that in each of the two axial halves the protective layer is guided from the bead region over the tire sidewall to below the tread.

An advantage of the two-wheeler pneumatic tire according to the invention, preferably of the bicycle tire, particularly preferably the racing bike and/or the mountain-bike tire, can be seen in the fact that the damage protection and puncture protection are significantly improved as a result of the novel tire construction. At the same time, the tire has good rolling resistance and high tightness.

It is essential to the invention that the first carcass ply is guided from the respective bead region in a first carcass ply turn-up over the respective tire sidewall to below the tread, and at the latter ends below the tread in the respective first carcass ply end. At the same time, the second carcass ply in its second carcass ply ends ends radially within the tread, in particular in the respective bead region. The second carcass ply is therefore not guided from the respective bead region over the tire sidewalls to below the tread.

In both axial halves of the tire, in a region of the sidewall, in particular radially between the second carcass ply end and the respective tread end of the tread, a reinforcement of the sidewall by three layer thicknesses of the carcass is provided, the first carcass ply contributing two layer thicknesses and the second carcass ply contributing one layer thickness. It is also essential that the sidewalls are moreover reinforced by the protective layer over their entire extent from the bead regions to the tread . The protective layer protects the carcass from axially outside. The cut resistance of the sidewalls and thus the damage protection is thus significantly improved. However, the sidewalls are not only better protected against damage, but are also stiffened over their entire height by the protective layer. The stiffening, especially due to the protective layer, leads to an increased advantageous puncture protection of the tire.

The additional reinforcement of the sidewall does indeed lead to increased friction loss and additional material input in the area of the sidewall. However, the conflict of objectives between damage protection and puncture protection of the sidewall versus rolling resistance is resolved at a high level in favor of damage protection and puncture protection.

Owing to the fact that the first carcass ply ends are disposed below the tread, the former are at the same time protected against delamination. This further improves the durability and damage protection of the two-wheeler tire.

Owing to the two carcass plies being wrapped around the core, the novel construction makes it possible both to maintain a simple tire construction and to advantageously protect the core against damage, in particular in comparison to a carcass that has only one carcass ply.

It has thus been demonstrated that a two-wheeler tire, preferably a bicycle tire, particularly preferably a racing bike and/or a mountain-bike tire, comprising the novel construction resolves the conflict of objectives of damage protection, in particular damage protection of the sidewall, and rolling resistance at a high level in favor of damage protection.

At the same time, the novel design further improves the airtightness of the tire. There is no direct connection between a tire interior and a tire exterior by way of one of the two carcass plies. Likewise, with the second carcass ply ends, the strength members of the second carcass ply ending there are covered with the protective layer from axially outside. This avoids, or greatly reduces, the discharge of air from the tire interior by way of the two carcass plies, especially in a tubeless operation. Together with the coverage of the carcass over the entire sidewall due to the protective layer from axially outside, an improved air tightness of the tire mounted on the rim is made possible.

If a layer is guided below the tread and ends there in a layer end, this layer end can be disposed spatially between the tread and the second carcass ply as well as radially outside and axially within the tread ends of the tread. A first straight line aligned perpendicularly to the second carcass ply can connect the tread and the respective layer end to one another. The layer can be the first carcass layer with the first carcass ply end as the layer end. The layer can also be a protective layer part of the protective layer, having a radially outer protective layer part end as the layer end.

In the bead region, the protective layer, in the manner of a bead protection tape, serves as normal as abrasion protection in relation to a rim flange during operation of the tire, and thus reduces the exposure of the carcass strength members. The protective layer can conjointly form, or form, an external face of the bead region designed as a contact surface to the rim.

The first carcass ply and the second carcass ply each have, as usual, parallel strength members which are embedded in rubber material. Here, the strength members may, in the conventional manner, enclose an angle of 40 degrees to 60 degrees with the revolving direction U. The strength members of the first carcass ply and of the second carcass ply may have opposing angles of inclination.

Advantageous refinements of the invention will be explained hereunder.

In one advantageous embodiment of the invention it is provided that each first carcass ply end is disposed below the tread in each case in that axial half of the tire in which the first carcass ply is guided in the first carcass ply turn-up, over the tire sidewall to below the tread, to the respective first carcass ply end.

The two first carcass ply turn-ups therefore do not overlap in the vertex of the tire. The first carcass ply ends are disposed in each case in the same axial half as the first carcass ply turn-up that ends in the respective first carcass ply end. The first carcass ply turn-ups are thus disposed so as to be restricted to the respective axial half of the tire. Axially between the first two carcass ply ends of the first carcass ply, the tire is thus reinforced by the carcass by way of exactly two layer thicknesses of the carcass.

Therefore, a two-wheeler pneumatic tire is provided which, with little input of carcass material, in particular in the vertex of the tire, ensures advantageous puncture protection of the sidewalls. Such a tire has a particularly low rolling resistance.

In particular, each first carcass ply end here is disposed below a tread runout of the tread in each case in that axial half of the tire in in which the first carcass ply is guided in the first carcass ply turn-up, over the tire sidewall to below the tread, to the respective first carcass ply end, and ends in the first carcass ply end disposed below the tread runout.

This further optimizes the rolling resistance owing to further reduced use of mutually overlapping carcass material. At the same time, the cutting resistance in the region of the sidewalls continues to be ensured, and it is made possible for the first carcass ply ends to be protected against delamination.

The first carcass ply in this instance ends in the first carcass ply ends below the tread runout. The first carcass ply ends can thus each be disposed spatially between the tread runout and the second carcass ply, and radially outside and axially within tread ends of the tread. A first straight line aligned perpendicularly to the second carcass ply can connect the tread runout and the first carcass ply end to one another.

In each axial half of the tire, the tread runout proceeding from the respective tread end can extend axially inward by at most 10 mm, preferably at most 2 mm, measured along a radially inner delimitation of the tread.

In an alternative advantageous refinement of the invention it is provided that the two first carcass ply turn-ups are disposed so as to overlap one another in the vertex of the tire.

Each of the two first carcass ply turn-ups extends from a bead region in one axial half of the tire to below the tread, and ends in the respective first carcass ply end in the respective other axial half of the tire. In the vertex of the tire, the tire is thus reinforced by the carcass by way of four layer thicknesses of the carcass, the first carcass ply contributing three layer thicknesses and the second carcass ply contributing one layer thickness.

While such a construction can have an adverse effect on rolling resistance, the cutting resistance of the tire in the region of the tread is greatly improved, the tire exhibiting further improved damage protection as a result. This is particularly important for all-season tires and for training tires for racing bikes.

In one advantageous refinement of the invention it is provided that the protective layer extends integrally from one bead region over the vertex to the other bead region of the two bead regions. This provides, with a simple construction, additional damage protection in the vertex.

In an alternative advantageous refinement of the invention it is provided that the protective layer is a protective layer divided into two protective layer parts: that in each of the two axial halves, a protective layer part of the two protective layer parts is guided from the bead region over the respective tire sidewall to below the tread and at the latter, in the respective axial half, ends in front of the vertex in a radially outer protective layer part end.

Preferably, the radially outer protective layer part end is disposed at most 3 mm axially within the tread end of the respective axial half, measured from the tread end along a radially inner delimitation of the tread.

Regardless of the design of the protective layer below the tread, it is advantageous for the protective layer, emanating from the sidewalls, in the bead regions to extend at most to a respective outermost reversal point of an external edge of the strength members of the second carcass ply that are folded about the core, and herein preferably to end in front of the respective outermost reversal point at a first height of 0 mm to 2 mm, measured relative to the outermost reversal point.

In order to determine a height in the bead region, in particular the first height or a second height mentioned below, the two-wheeler pneumatic tire in cross-section thereof can be bent upward in such a way that the two carcass plies, emanating from the vertex, are disposed largely rectilinearly in the region of the sidewall, and transition to a wrapping of the core that is largely symmetrical in terms of the core. In this arrangement, the respective height is measured relative to the outermost reversal point of the external edge of the strength members of the second carcass ply that are folded about the core, measured parallel to the carcass plies that are disposed largely rectilinearly. The second carcass ply ends, like the first carcass ply ends and the ends of the protective layer, can be provided by the ends of the strength members, in particular by a woven fabric edge, of the respective carcass ply or protective layer.

In one advantageous refinement of the invention it is provided that the second carcass ply in the second carcass ply end thereof ends in the respective bead region, in particular in front of the respective sidewall when proceeding from the core.

Due to the second carcass ply ends being disposed so low in the bead region, in particular in front of the respective sidewall when emanating from the core, the turn-ups of the second carcass plies are disposed primarily in an region which experiences little or no cyclic deformation during operation of the tire. Thus, the energy loss due to friction of the second carcass ply is minor. Likewise, the material input for the second carcass ply, and thus the weight of the tire, is minor.

Corresponding advantages are derived when the second carcass ply in the second carcass ply ends ends at a second height of at most 15 mm, preferably from 10 mm to 12 mm, measured relative to the outermost reversal point.

In a preferred embodiment, the protective layer is embodied as a woven fabric rubberized with the rubber material, wherein the woven fabric comprises the strength members. The woven fabric can be a woven cord fabric or a woven cross-ply fabric. A particularly good airtightness is achieved with a woven cross-ply fabric comprising monofilaments as strength members.

In one advantageous embodiment, the woven fabric has a thread density of at least 100 epdm. This may be a woven canvas fabric.

In one advantageous embodiment, the strength members are made of polyester or polyamide, preferably polyamide 6, particularly preferably polyamide 6.6. In one advantageous embodiment, the breaking force of the individual strength member is at least 15 N.

In a further advantageous refinement of the invention it is provided that the strength members of the protective layer are monofilaments, in particular monofilaments of a woven monofilament fabric. The protective layer thus comprises in particular a woven monofilament fabric rubberized with the rubber compound, wherein the woven monofilament fabric comprises the strength members configured as monofilaments.

The protective layer strength members embodied as monofilaments, in particular the rubberized woven monofilament fabric, reduce the escape of air at the contact face between the tire and the rim particularly effectively, in particular more effectively than strength members consisting of a plurality of twisted fibers. The reason for this is that the monofilaments are embedded largely individually in the rubber material of the protective layer and thus a discharge of air through microchannels between the fibers of the threads is largely avoided. This enables the tire mounted on a rim to be particularly airtight. This is advantageous in particular for a tubeless tire. Operation of the tire without a tube can therefore be made possible without further complex measures that often worsen the rolling resistance, such as an inner liner. Furthermore, the improved airtightness allows the tubeless tire to be driven with only little or no sealant fluid.

In a further advantageous refinement of the invention it is provided that the rubber material of the protective layer is colored or white.

Since the rubber material of the protective layer only slightly influences the performance of the tire, a colored or white rubber material can also be selected for this purpose. Since the protective layer conjointly forms the visible surface of the tire, a targeted optical design of the tire is thus possible.

In a further advantageous refinement of the invention it is provided that the carcass is in direct contact with a tire interior. This makes it possible to obtain a particularly lightweight tire and thus an advantageous rolling resistance. For a tubeless tire, in particular a “tubeless” or a “tubeless ready” bicycle tire, a sufficient airtightness can be ensured by the measures described, in particular the design having a woven monofilament fabric.

In a further advantageous refinement of the invention it is provided that the tire is a tubeless tire, in particular a “tubeless” tire or a “tubeless ready” tire.

Tubeless tires are tires that are suitable and intended for the tire to be operated without a tube. Tubeless tires are in particular tires in a tubeless operation. A tire in the tubeless operation is a tire which is mounted on a rim, the tire interior enclosed by the tire and rim being free of a tube and the tire being operated in such a manner. Tubeless tires place increased demands on the airtightness of the tire per se as well as on the seal at the tire/rim contact surface. In the tubeless operation of the tubeless tire, friction losses between tube and tire are absent so that the tire enables an advantageous rolling resistance. Reasons for damage relating to tubes are likewise dispensed with. When operating a tubeless tire in the tubeless operation, the use of a sealing liquid, in particular a sealant fluid, which is introduced into the tire interior between the tire and the rim, can improve the tightness.

A tubeless tire may be a so-called “tubeless” tire, which is primarily or exclusively suitable for operation without a tube. A tubeless tire can often also be driven without a sealant fluid.

The tubeless tire may also be a so-called “tubeless ready” tire, which is suitable and intended both for operation with and for operation without a tube. Typically, a tubeless ready tire is used with a sealing liquid, in particular a sealant fluid, in tubeless operation. The tire and rim may be designed here so as to seal directly in relation to one another.

The invention is particularly advantageous for tubeless bicycle tires, in particular tubeless racing bike tires and/or tubeless mountain bike tires.

In a further advantageous development of the invention, it is provided that the tire is a bicycle tire suitable and intended for operation with a tube, in particular a clincher tire. A tire in a tubular operation is a tire mounted on a rim, with a largely air-tight tube disposed in a tire interior enclosed by the tire and the rim. When a tire is operated with a tube, the air pressure is maintained by means of a largely air-tight tube disposed in the tire interior tire between tire and rim. Here, too, the novel tire construction permits an advantageously reduced rolling resistance.

A so-called clincher tire is typically a wire-based tire or a folding tire. The tire then has a wire core or a folding core and is mounted with the bead on the rim flange of the rim. A clincher tire can be mounted and removed using simple means. In the event of a breakdown, the damage can thus be easily repaired.

In a further advantageous development of the invention it is provided that one or two intermediate layers is/are disposed between the tread and the tire carcass.

At least one intermediate layer of the one or two intermediate layers can be a rubber insert.

The rubber insert here may be formed from a hard rubber mixture, wherein the rubber insert in particular has a material thickness of at most 6 mm, measured in the tire vertex. The rubber insert can be a rubber breaker. The hard rubber compound can have a Shore hardness A of more than 45 and a rebound value of more than 60, by way of which the hard rubber compound is distinguished by a high crack resistance and a high breaking force. The hard rubber insert serves as additional damage protection.

The rubber insert may also be a damping rubber insert made of a highly elastic rubber, wherein the damping rubber insert in particular has a material thickness of 0.2 mm to 1 mm, measured in the tire vertex. Greater ride comfort and better rolling resistance are thereby made possible by decoupling the fabric plies. The special material thickness of 0.2 mm to 1 mm of the damping rubber insert significantly improves the ride comfort of the bicycle tire, as the bicycle tire overall is better able to adapt to the road surface. Furthermore, the additional rubber insert enhances the damage protection in the vertex.

The damping rubber insert may preferably consist of a highly elastic rubber having a material rebound value between 70 and 80. Optimum ride comfort is achieved with this material rebound value, the rolling resistance of the bicycle tire not being simultaneously increased.

At least one intermediate layer of the one or two intermediate layers may be a particularly tear-resistant rubberized woven fabric, preferably a particularly tear-resistant rubberized woven fabric comprising fibers of polyethylene terephthalate—polyacrylate.

The protective layer guarantees optimum damage protection in the vertex for the two-wheeler pneumatic tire, preferably the bicycle tire, particularly preferably the road bike tire or the mountain bike tire. The particularly tear-resistant rubberized woven fabric comprising fibers of polyethylene terephthalate—polyacrylate, may be a rubberized woven fabric which comprises Vectran fibers or consists of the latter.

If the tire has two intermediate layers, it is preferably the in particular tear-resistant rubberized woven fabric as well as one of the two mentioned rubber inserts.

In a further advantageous refinement of the invention it is provided that

the tire is a bicycle tire, in particular a racing bike tire, a mountain bike tire or a tire for a bicycle having an electric motor for driving the bicycle. The novel tire construction is however suitable for use in all types of bicycles.

The novel tire construction can be used particularly advantageously in racing bikes, especially as tubeless tires, as the novel tire construction has a low rolling resistance. A racing bike tire usually has a maximum tire width of 35 mm and exhibits a racing bike-specific low profiling of the tread.

The novel tire construction, especially for tubeless tires, is also ideally suited to mountain bike tires. Mountain bike tires usually have a minimum tire width of 35 mm, in particular 40 mm, and often have a pronounced profiling of the tread. Aspects such as the rolling resistance are also becoming increasingly important for mountain bike tires. In particular, a tubeless operation of the tire may be advantageous, because then the susceptibility to punctures is reduced and such a tire can be used at a comparatively lower air pressure.

Due to the advantageous damage protection and puncture protection, the tire according to the invention is particularly suitable for training road bike tires as well as for tires that are driven particularly on uneven ground that promotes damage and punctures, such as gravel tires, offroad tires, and mountain bike tires. There are also corresponding advantages for applications in the cargo-handling sector.

The novel tire construction is also ideally suited for use on bicycles having an electric motor for driving the bicycle. In such use, a low rolling resistance is advantageous because it increases the range of the bicycle.

The tire may be a tire for an electric bicycle. A tire for an electric bicycle, in particular an e-bike or an S-pedelec, can meet the “ECE-R75” testing standard. The tire can be a tire for a pedelec, in which the drive is at least partially supported by the electric motor only when pedaling, in particular up to a speed of 25 km/h.

In a further advantageous refinement of the invention it is provided that the tire is a motorcycle tire, in particular an electric scooter tire. A motorcycle tire or an electric scooter tire having the novel construction can also contribute, by way of the advantageous rolling resistance, toward an improved range of the vehicle.

### BRIEF DESCRIPTION OF THE DRAWINGS

Further features, advantages and details of the invention will now be explained in more detail by means of the schematic drawings, which represent exemplary embodiments, and comparison data. In the drawings:

FIGS. 1 and 2: show a two-wheeler pneumatic tire according to the invention in the cross section: and

FIG. 3: shows a fragment of a two-wheeler tire in the cross section.

### DETAILED DESCRIPTION

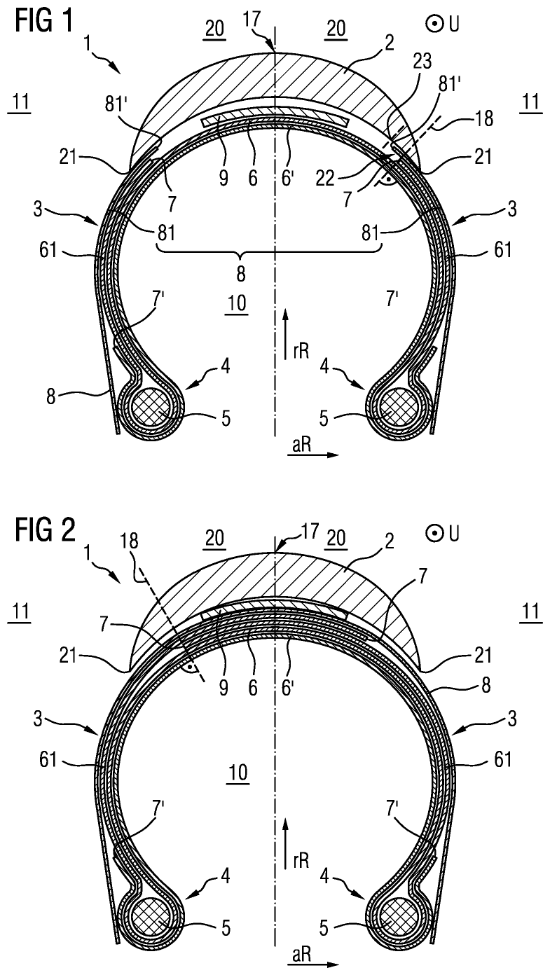

FIGS. 1 and 2 each show the substantial tire components of a two-wheeler tire 1 in a cross-sectional view. This is a two-wheeler pneumatic tire 1, preferably bicycle tire, particularly preferably road or mountain bike tire, having a tread 2, a tire carcass, tire sidewalls 3, and in each axial half 20 of the tire a bead region 4 with a tire bead having a core 5, wherein the two-wheeler pneumatic tire 1 in the bead regions 4 has a protective layer 8 which is disposed axially outside the carcass and which has strength members embedded in rubber material.

The tire carcass is formed from a first carcass ply 6 and a second carcass ply 6′, each having strength members. The strength members within the respective carcass ply here are typically disposed so as to be mutually parallel and at an angle of 40 degrees to 60 degrees in relation to the revolving direction U. The strength members of the two carcass plies 6, 6′ may have opposing angles of inclination. The tire I may at least be symmetrical in terms of the carcass plies 6, 6′.

The second carcass ply 6′ in a vertex 17 of the tire 1 is disposed radially within the first carcass ply 6. Said second carcass ply 6′ extends from the vertex 17 of the two-wheeler pneumatic tire 1 over the tire sidewalls 3 to both bead regions 4, and in the latter wraps the respective core 5 from axially inside to axially outside, and ends in a second carcass ply end 7′ radially within the respective tread end 21, in particular in the respective bead region 4, as illustrated.

The first carcass ply 6 extends from the vertex 17 of the tire 1 over the tire sidewalls to both bead regions 4, and in the latter wraps the respective core from axially inside to axially outside.

The two-wheeler tire is distinguished in that the first carcass ply 6 is guided from the respective bead region 4 in a first carcass ply turn-up 61 over the respective tire sidewall 3 to below the tread 2 and at the latter ends in each case in a first carcass ply end 7, and in that in each of the two axial halves 20 the protective layer 8 is guided from the bead region 4 over the respective tire sidewall 3 to below the tread 2.

The first carcass ply 6 ends at the first carcass ply ends 7 below the tread 2. The first carcass ply ends 7 can thus each be disposed spatially between the tread 2 and the second carcass ply 6′, and radially outside and axially within the tread ends 21 of the tread. A first straight line 18 aligned perpendicularly to the second carcass ply 6′ can connect the tread 2 and the first carcass ply end 7 to one another.

The protective layer 8 at least conjointly forms an external face of the bead region designed as a contact surface to the rim. The protective layer covers the respective second carcass ply end 7′ from axially outside.

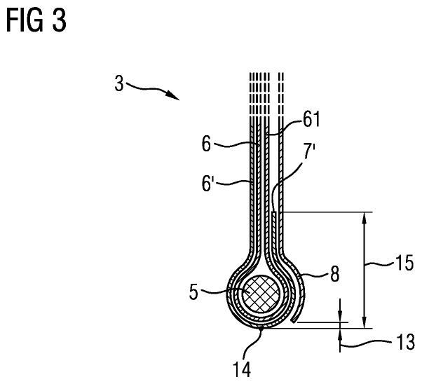

The protective layer 8, emanating from the sidewalls 3, in the bead regions 4 extends at most to a respective outermost reversal point 14 of an external edge of the strength members of the second carcass layer 6′ which are folded about the core, and here ends in front of the respective outermost reversal point 14 at a first height 13 of 0 to 2 mm, measured relative to the outermost reversal point. The sizing of the first height 13 is visualized in FIG. 3.

The second carcass ply 6′ ends in the second carcass ply ends 7′ in the respective bead region 4, in particular in front of the respective sidewall 3 when emanating from the core. The second carcass ply ends 7′ of the second carcass ply 6′ may be disposed at a second height 15 of at most 15 mm, preferably of 10 mm to 12 mm, measured relative to the outermost reversal point 14 . Sizing of the second height 15 is highlighted in FIG. 3.

In a preferred embodiment, the protective layer is embodied as a woven fabric rubberized with the rubber material, wherein the woven fabric comprises the strength members. The woven fabric can be a woven cord fabric or a woven cross-ply fabric. A particularly good airtightness is achieved with a woven cross-ply fabric comprising monofilaments as strength members.

In one advantageous embodiment, the woven fabric has a thread density of at least 100 epdm. This may be a woven canvas fabric. In one advantageous embodiment, the strength members are made of polyester or polyamide, preferably polyamide 6, particularly preferably polyamide 6.6. In one advantageous embodiment, the breaking force of the individual strength member is at least 15 N.

The strength members of the protective layer 8 may be monofilaments, preferably monofilaments of a woven monofilament fabric.

The carcass is in direct contact with the tire interior 10. The tire 1 in particular has no inner liner. Advantages according to the invention can however also be achieved by a tire 1 which has a further layer, in particular an inner liner, between tire interior 10 and carcass.

As is illustrated, a damping rubber insert made of a highly elastic rubber is disposed as an intermediate layer 9 between the tread 2 and the tire carcass, wherein the damping rubber insert 9 in particular has a material thickness between 0.2 mm and 1 mm, measured in the tire vertex. The damping rubber insert may preferably consist of a highly elastic rubber having a material rebound value between 70 and 80.

However, the intermediate layer 9 can alternatively also be formed from a hard rubber mixture, wherein the rubber insert in particular has a material thickness of a maximum of 6 mm, measured in the tire vertex. The rubber insert can be a rubber breaker. The hard rubber compound may have a Shore hardness A greater than 45 and a rebound value greater than 60.

Alternatively or additionally to the rubber insert, a protective layer which is not illustrated and, as an intermediate layer, comprises an in particular tear-resistant rubberized woven fabric, preferably a rubberized woven fabric comprising fibers of polyethylene terephthalate—polyacry late, may be disposed between the tread 2 and the tire carcass.

The tire illustrated is in each case be a tubeless tire, in particular a “tubeless” tire or a “tubeless ready” tire. The tire may be suitable, intended and used for tubeless operation. A tire for operation with a tube, in particular a clincher tire, can however also have an advantageous construction with corresponding features.

The tires illustrated are a racing bike tire. Alternatively, it can also be another bicycle tire, especially a mountain bike tire. But also other tires, in particular tires for a bicycle having an electric motor for driving the bicycle, can be designed accordingly. Motorcycle tires, in particular electric scooter tires, can also have the advantageous construction illustrated.

The embodiments of FIGS. 1 and 2 differ in the extent of the first carcass ply turn-ups 61 and the design of the protective layer 8 below the tread 2:
FIG. 1 shows a tire 1 with particularly low rolling resistance. Here, each first carcass ply end 7 is disposed below the tread 2, in particular as illustrated below a tread runout 22 of the tread, in each case in that axial half 20 of the tire 1 in which the first carcass ply 6 is guided in the first carcass ply turn-up 61, over the tire sidewall 3 to below the tread 2, to the respective first carcass ply end 7. In the respective axial half 20 of the tire, the tread runout 22 extends, proceeding from the respective tread end 21, axially inward by at most 10 mm, preferably at most 2 mm, as measured along a radially inner boundary of the tread, to an axially inner tread runout end 23.

The two first carcass ply turn-ups 61 therefore do not overlap in the vertex 17 of the tire 1. The first carcass ply ends 7 are disposed in each case in the same axial half 20 as that first carcass ply turn-up 61 that terminates at the respective first carcass ply end 7. The first carcass ply turn-ups 61 are thus disposed so as to be restricted to the respective axial half 20 of the tire.

The protective layer 8 illustrated in FIG. 1 is a protective layer divided into two protective layer parts 81, in which in each of the two axial halves 20 a protective layer part 81 of the two protective layer parts is guided from the bead region 4 over the respective tire sidewall 3 to below the tread 2 and at the latter, in the respective axial half 20, ends in front of the vertex 17 in a radially outer protective layer part end 81′.

The radially outer protective layer part ends 81′ can thus each be disposed spatially between the tread 2 and the second carcass ply 6′ and radially outside and axially within the tread ends 21 of the tread. A first straight line aligned perpendicularly to the second carcass ply 6′ can connect the tread 2 and the radially outer protective layer part end 81′ to one other (not shown).

As shown, the respective radially outer protective layer part end 81′ can be disposed at most 3 mm axially within the tread end 21 of the respective axial half 20, measured from the tread end 21 along a radially inner delimitation of the tread.

A corresponding embodiment of the protection layer 8 is also compatible with a tire according to FIG. 2.

FIG. 2 shows a tire 1 with particularly good damage protection. As opposed to the tire illustrated in FIG. 1, the two first carcass ply turn-ups 7 are disposed so as to overlap one another in the vertex 17 of the tire 1. Each of the two first carcass ply turn-ups 61 extends from a bead region 4 in one axial half 20 of the tire to below the tread 2, and ends in the respective first carcass ply end 7 in the respective other axial half 20 of the tire. Thus, in the vertex 17 of the tire, the tire 1 is reinforced by four layer thicknesses of the carcass, as illustrated.

The protective layer 8 illustrated in FIG. 2 extends integrally from one bead region 4 over the vertex 17 to the other bead region 4 of the two bead regions 4. This embodiment of the protective layer 8 is also compatible with a tire according to FIG. 1.

FIG. 3 highlights the sizing of the first height 13 and of the second height 15. In order to determine the first height 13 and the second height 15, the two-wheeler pneumatic tire 1 in the cross section thereof can be bent upward in such a way that the two carcass plies 6, 6′, emanating from the vertex 17, are disposed largely rectilinearly in the region of the sidewall 3, and transition to a wrapping of the core 5 that is largely symmetrical in terms of the core 5. This can be a fragment of the tire of FIG. 1 or FIG. 2, wherein the two-wheeler pneumatic tire 1 in the cross section thereof is correspondingly bent upward. In this arrangement, the first height 13 and the second height 15 are measured relative to the outermost reversal point 14 of an external edge of the strength members of the second carcass ply 6′ that are folded around the core 5, and measured parallel to the carcass plies 6, 6′ disposed substantially rectilinearly in the region of the sidewall 3.

### Tests

Tests were carried out with three different tubeless racing bike tires. Here, the tire RI according to the invention, configured according to FIG. 1 without an intermediate layer 9, was tested. Moreover, a reference tire RR2, which in terms of construction is largely identical to the RI tire, but in contrast to the RI tire, instead of the protective layer has a customary bead protection tape which covers the second carcass layer ends and already ends in the bead region, was tested. Furthermore, as a reference tire RR3, a commercially available tubeless racing bike tire having exactly one carcass ply was tested, wherein the turn-ups of the carcass ply of the reference tire RR3 are disposed so as to overlap one another in the vertex. The reference tire RR3 furthermore has an inner liner for adequate airtightness. The results are collated in Table 1.

TABLE 1

| Tire | R1 | RR2 | RR3 |
|---|---|---|---|
| Weight [g] | 281 | 263 | 296 |
| Rolling resistance [W] | 14.1 | 12.9 | 14.1 |
| Sidewall cutting resistance [N] | 498 | 452 | 346 |

The difference in the weight of RI and RR2 tires is solely due to the protective layer. Despite having a single-layer carcass, the tire RR3 is heavier than the other tires owing to the inner liner layer.

The rolling resistance was measured at a maximum pressure of 7.5 bar and on a 19C rim without tube and sealant fluid (tubeless). Here, the influence of energy loss due to friction between layers comprising strength members is evident. The RR2 reference tire, which has the lowest input of material in the sidewall and the lowest weight, also has the lowest rolling resistance. The R1 tire with the protective layer in the sidewall has a rolling resistance comparable to the rolling resistance of the commercially available RR3 tubeless tire with a single carcass layer.

The cutting resistance was measured with the aid of force measurements when the sidewall is pierced by a blade (comparable to rocks on the road surface). The number of reinforcing layers is important for blade measurements. Accordingly, the cutting resistance in the region of the sidewall of the R1 tire according to the invention is improved by more than 10% in comparison to the reference RR2 tire without a protective layer in the sidewall, and by more than 40% in comparison to the reference RR3 tire with only one carcass layer.

It is thus demonstrated that the R1 tire according to the invention resolves the conflict of objectives between damage protection and puncture protection of the sidewall, airtightness and high-level rolling resistance in favor of damage protection and puncture protection of the sidewall.

### List of Reference Signs

### (part of the description)

1 Two-wheeler pneumatic tire
2 Tread
3 Sidewall
4 Bead region
5 Core
6 First carcass ply
6′ Second carcass ply
7 First carcass ply end
7′ Second carcass ply end
8 Protective layer
9 Rubber insert
10 Tire interior
11 Tire exterior
13 First height
14 Outermost reversal point
15 Second height
17 Vertex
18 First straight line
20 Axial half
21 Tread end
22 Tread runout
23 Axially inner tread runout end
81 Protective layer part
81′ Radially outer protective layer part end
rR Radial direction
aR Axial direction
U Revolving direction

1-14. (canceled)

15. A two-wheeler pneumatic tire comprising:
a tread;
a tire carcass;
tire sidewalls;
a bead region having a tire bead with a core;
the bead region has a protective layer disposed axially outside the carcass and has strength members embedded in rubber material;
the tire carcass formed from a first carcass ply and a second carcass ply, each having strength members;
the second carcass ply is disposed in a vertex of the tire radially within the first carcass and extends from the vertex over the tire sidewalls to the bead regions, and in the latter wraps the core from axially inside to axially outside, and ends in a second carcass ply end radially within a tread end of the tread; and
the first carcass ply extends from the vertex of the two-wheeler pneumatic tire over the tire sidewalls to the bead regions, and in the latter wraps the core from axially inside to axially outside; and
the first carcass ply is guided from the bead region in a first carcass ply turn-up over the respective tire sidewall to below the tread and at the latter ends in a first carcass ply end; and
each of two axial halves of the protective layer is guided from the bead region over the respective tire sidewall to below the tread.

16. The tire of claim 15, further comprising a tread runout of the tread in an axial half in which the first carcass ply is guided in the first carcass ply turn-up, over the tire sidewall to below the tread, to the respective first carcass ply end.

17. The tire of claim 15, wherein the first carcass ply turn-up and the second carcass ply turn-up overlap one another in the vertex.

18. The tire of claim 15, wherein the protective layer extends integrally from one bead region over the vertex (17) to another bead region.

19. The tire of claim 15, wherein the protective layer is divided into two protective layer parts; in that in each of the two axial halves a protective layer part of the two protective layer parts is guided from the bead region over the respective tire sidewall to below the tread and at the latter, in the respective axial half, ends in front of the vertex in a radially outer protective layer part end.

20. The tire of claim 15, wherein the protective layer emanates from the sidewalls in the bead regions and extends at most to a respective outermost reversal point of an external edge of the strength members of the second carcass ply that are folded about the core, and herein ends in front of the respective outermost reversal point at a first height of 0 to 2 mm, measured relative to the outermost reversal point.

21. The tire of claim 15, wherein the protective layer is embodied as a woven fabric rubberized with the rubber material.

22. The tire of claim 15, wherein the strength members of the protective layer are monofilaments.

23. The tire of claim 15, wherein the protective layer has a colored rubber coating or a white rubber coating.

24. The tire of claim 15, wherein the carcass is in direct contact with a tire interior.

25. The tire of claim 15, wherein the tire is airtight and operable without a tube.

26. The tire of claim 15, further comprising a folding core mounted with the bead on a rim flange.

27. The tire of claim 15, the tire carcass comprises a plurality of intermediate layers of a tear-resistant woven fabric.

28. The tire of claim 15, the tire carcass comprises a protective rubber insert having a rubber compound with a Shore hardness of more than 45 and a rebound value of more than 60.
